(19) United States
(12) Patent Application Publication
(10) Pub. No.: US 2024/0332996 A1
(43) Pub. Date: Oct. 3, 2024

(54) BATTERY ENERGY STORAGE SYSTEM

(71) Applicants: Beijing Jiaotong University, Beijing (CN); Delta Electronics (Shanghai) Co.,Ltd., Shanghai (CN)

(72) Inventors: Long JING, Beijing (CN); Weige ZHANG, Beijing (CN); Xuezhi WU, Beijing (CN); Fen TANG, Beijing (CN); Jingdou LIU, Beijing (CN); Yucheng WU, Beijing (CN)

(21) Appl. No.: 18/613,148

(22) Filed: Mar. 22, 2024

(30) Foreign Application Priority Data
Mar. 27, 2023 (CN) 202310308331.0

(51) Int. Cl. H02J 7/00; H01M 10/42; H01M 50/204; H01M 50/51; H01M 50/512; H02M 1/00; H02M 3/00; H02M 3/335

(52) U.S. Cl. CPC H02J 7/0031; H01M 10/4264; H01M 50/204; H01M 50/51; H01M 50/512; H02M 1/008; H02M 3/01; H02M 3/33573; H02M 3/33576

(57) ABSTRACT

The battery energy storage system comprising: a bus connection portion comprising a positive bus connection end and a negative bus connection end; a first battery pack comprising a plurality of single batteries connected in series or in parallel; an output capacitor is connected in series to the first battery pack, the output capacitor and the first battery pack are connected between the positive bus connection end and the negative bus connection end; a H-bridge circuit having an output end connected to the output capacitor; a first isolated DC/DC conversion circuit having an input end electrically connected to the first battery pack, an output end electrically connected to an input end of the H-bridge circuit; a first relay electrically connected between the first battery pack and the input end of the first isolated DC/DC conversion circuit, when the first isolated DC/DC conversion circuit has fault, the first relay is disconnected.

### CROSS-REFERENCE TO RELATED APPLICATIONS

This non-provisional application claims priority under 35 U.S.C. § 119(a) on Patent Applications No. 202310308331.0 filed on Mar. 27, 2023, in P.R. China, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNOLOGY FIELD

The disclosure relates to the technical field of power supply systems, and particularly relates to a battery energy storage system.

### BACKGROUND

The battery energy storage system has rapid regulation performance, which can smooth output fluctuation of new energy power generation and eliminate congestion of power grid, and is the important resource for enhancing the capability to connect and absorb new energy power generation in the future power system. In the traditional battery energy storage system, the single batteries satisfy the requirements for a high voltage and a large capacity with assistance of simple protection or an equalization circuit through different combinations of series and parallel connections, and when the single battery in the pack is overcharged or overdischarged, the whole series-connected batteries will be out of operation, so utilization of capacity of the battery pack is insufficient, and powering reliability is poor.

Utilization of battery pack is the practical demand, and also an effective technical means, and in order to reduce influence of inconsistency of the single batteries on the battery energy storage system, the relevant fields propose flexible pack way of the flexible batteries. In the battery flexible pack system, the single batteries with similar parameters are often packed at a small scale to form low-voltage battery modules in series and parallel connection forms, the low-voltage battery modules and energy storage converters form energy storage units, and finally, the energy storage units are cascaded, such that a current of each battery module during charging and discharging can be independently controlled, thereby controlling charge and discharge of the entire battery pack. The flexible pack way is divided into an AC connection scheme and a DC connection scheme, and the battery energy storage system based on H-bridge cascade and MMC is only suitable for AC connection occasion, so the application range is limited, while reliability of the system is poor, and cost is high. Moreover, after the battery energy storage units are formed using DC/DC converters, series connection can solve the requirement for a high voltage only, and as for the parallel connection way, the batteries also shall be connected in series to a high voltage, where the converter has a large power capacity using converter full power control.

### SUMMARY

With respect to the deficiencies in the prior art, the disclosure provide a battery energy storage system, and can achieve the occasions such as fault isolation, step-up, flow expanding or AC and DC modulation through different pack ways of the battery modules.

In order to achieve the object, on one hand, the disclosure provide a first battery energy storage system, comprising:

a bus connection portion, comprising a positive bus connection end and a negative bus connection end;

a first battery pack, comprising a plurality of single batteries connected in series, or a plurality of single batteries connected in parallel;

an output capacitor, wherein the output capacitor is connected in series to the first battery pack, and the output capacitor and the first battery pack are electrically connected between the positive bus connection end and the negative bus connection end;

a H-bridge circuit, wherein an output end of the H-bridge circuit is electrically connected to the output capacitor;

a filter inductor, wherein the filter inductor is electrically connected between the output end of the H-bridge circuit and the output capacitor;

a first isolated DC/DC conversion circuit, wherein an input end of the first isolated DC/DC conversion circuit is electrically connected to the first battery pack, and an output end of the first isolated DC/DC conversion circuit is electrically connected to an input end of the H-bridge circuit; and

a first relay, wherein the first relay is electrically connected between the first battery pack and the input end of the first isolated DC/DC conversion circuit, and when the first isolated DC/DC conversion circuit has fault, the first relay is disconnected.

### BRIEF DESCRIPTION OF THE DRAWINGS

In order to illustrate the technical solutions in the embodiments of the present disclosure more clearly, the figures required for describing the embodiments will be introduced briefly. Obviously, the figures in the description are just some of embodiments of the present disclosure. For the general technical staff in this field, they can also obtain other figures based on those figures without creative work.

FIG. 1 is a topological diagram of a battery energy storage system operating based on a part of power according to a first embodiment of the disclosure.

FIG. 2 is a schematic diagram of a specific circuit according to the first embodiment of the disclosure.

FIG. 3 is a topological schematic diagram of a battery energy storage system with a step-up scheme according to a second embodiment of the disclosure.

FIG. 4 is a topological schematic diagram of a battery energy storage system with a flow expanding scheme according to a third embodiment of the disclosure.

FIG. 5 is a topological schematic diagram of a battery energy storage system based on AC or DC output according to a fourth embodiment of the disclosure.

FIG. 6 is a specific circuit diagram of a H-bridge circuit according to the fourth embodiment of the disclosure.

FIG. 7a shows modulated principle waveforms based on AC output.

FIG. 7b shows modulated principle waveforms based on DC output.

### DETAILED DESCRIPTION

To make the features and effects of the disclosure clearer and more apparent, hereinafter detailed explanations are made with reference to the embodiments and the accompanying drawings.

As is stated previously, in the prior art, the traditional battery energy storage system connects the batteries in series and parallel and adopts the post-stage full power scheme, and since parameters of capacity and inner resistance of the single cells of the battery are inconsistent, performance of the entire battery pack is far less than that of the single battery, so energy and capacity of the battery pack cannot be fully utilized, and application of the large scale battery energy storage system is limited. Moreover, the DC/DC converters in the current battery flexible pack way use non-isolated full power control, the converter has a large power capacity, and when facing AC or DC connection occasion, the topological structure shall be changed. When the flexible packing energy storage system has fault, the non-isolated DC/DC converters cannot completely cut off the battery pack and the DC bus, and reliability of the system is poor.

On such basis, the disclosure provide a battery energy storage system, which forms a unit battery module using the energy storage battery pack and the isolated DC/DC conversion circuit, and can be convenient for flexible packing and various expanding applications. When the DC/DC conversion circuit in the battery energy storage system has fault, electric isolation of the faulted DC/DC conversion circuit may be achieved by pulse blocking of the isolated DC/DC conversion circuit and the H-bridge circuit, thereby largely improving reliability and safety of the battery pack during operation.

The disclosure form different battery energy storage systems through different combinations of the battery modules, can be suitable for occasions such as an alternating current, a direct current and a large power, and also achieves miniaturization and a light weight while improving operating efficiency of the energy storage systems. Specifically, it includes:

### Embodiment One

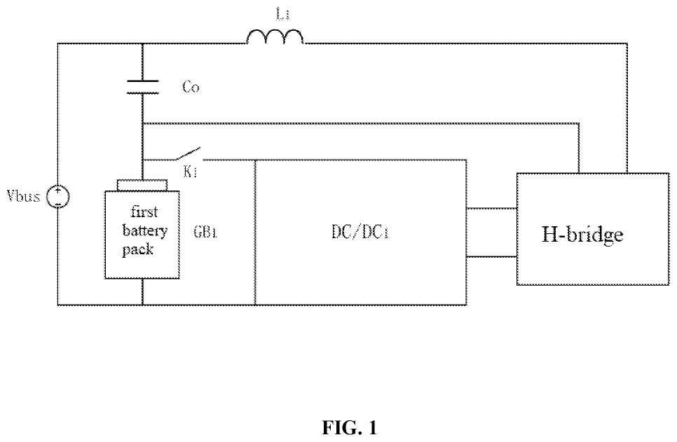

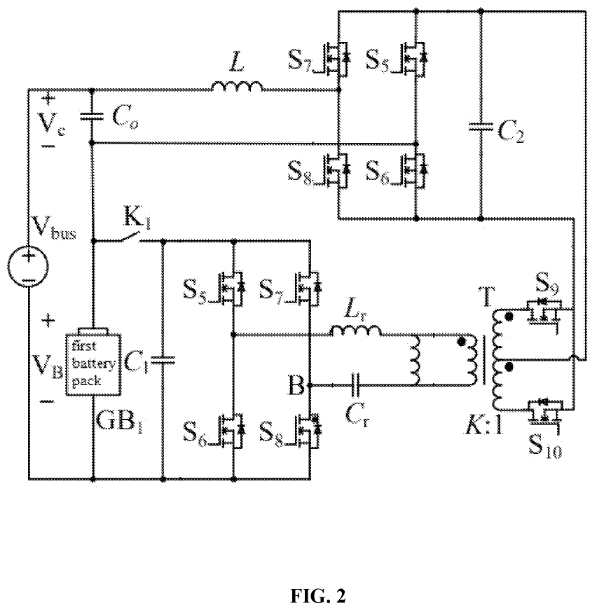

As shown in FIG. 1, FIG. 1 illustrates a topological diagram of a high-safety operating battery energy storage system processed based on a part of power provided in embodiment one, and FIG. 2 illustrates a principle diagram of a specific circuit in one embodiment of the battery energy storage system.

Specifically, referring to FIG. 1, the battery energy storage system is a high-safety operating energy storage system processed based on a part of power, and comprises:

a bus connection portion Vbus comprising a positive bus connection end and a negative bus connection end;

a first battery pack GB₁ comprising a plurality of single batteries connected in series or in parallel;

an output capacitor C_{O}, wherein the output capacitor C_{O} is connected in series to the first battery pack GB₁, and the output capacitor C_{O} and the first battery pack GB₁ are electrically connected between the positive bus connection end and the negative bus connection end;

a H-bridge circuit, wherein an output end of the H-bridge circuit is electrically connected to the output capacitor C_{O};

a filter inductor L1 electrically connected between the output end of the H-bridge circuit and the output capacitor C_{O};

a first isolated DC/DC conversion circuit DC/DC₁, wherein an input end of the first isolated DC/DC conversion circuit DC/DC₁ is electrically connected to the first battery pack GB₁, and an output end of the first isolated DC/DC conversion circuit DC/DC₁ is electrically connected to an input end of the H-bridge circuit;

and a first relay K₁ electrically connected between the first battery pack GB₁ and the input end of the first isolated DC/DC conversion circuit DC/DC₁, and when the first isolated DC/DC conversion circuit DC/DC₁ has fault, the first relay K₁ is disconnected.

Further, as shown in FIG. 2, the first isolated DC/DC conversion circuit comprises a LLC resonant conversion circuit, and the LLC resonant conversion circuit is electrically connected to a first capacitor C1, a switching circuit, a resonant network, a transformer, a rectifier circuit and a second capacitor C2 sequentially, the switching circuit comprises a first bridge arm and a second bridge arm, the first capacitor C1, the first bridge arm and the second bridge arm are connected in parallel, the first bridge arm comprises a first switch S1 and a second switch S2 connected in series, the second bridge arm comprises a third switch S3 and a fourth switch S4 connected in series, the resonant network comprises a resonant inductor Lr and a resonant capacitor Cr, the H-bridge circuit comprises a third bridge arm and a fourth bridge arm, the second capacitor C2, the third bridge arm and the fourth bridge arm are connected in parallel, the third bridge arm comprises a fifth switch S5 and a sixth switch S6 connected in series, the fourth bridge arm comprises a seventh switch S7 and an eighth switch S8, and the rectifier circuit comprises a ninth switch S9 and a tenth switch S10.

In this embodiment, since a working voltage of the single battery is low, and the working voltage of the single battery is about 26.7V to 33.5V, the plurality of single batteries are connected in series to a first battery pack GB₁ to improve a voltage class. The battery energy storage system has one end connected to a DC bus voltage 400V, and the other end connected to the first battery pack with a voltage range of 347.1 V to 435.5 V and a battery peak power of 7.4 kW formed by connecting a plurality of single batteries (this embodiment particularly uses thirteen single batteries) in series. Specifically, as can be seen from FIG. 2, one side of the first battery pack GB₁ connected to the LLC resonant conversion circuit is an input end, and an input voltage VB has a range of 347.1V to 435.5V, which is a high-voltage side; the H-bridge circuit is cascaded after the LLC resonant conversion circuit, the other side of the H-bridge circuit is an output end, and an output voltage V_{C} has a range of −60V to 60V, which is a low-voltage side. Based on power conversion technology of the PPC portion, the low-voltage side voltage V_{C} is a difference between the DC bus voltage V_{bus} and the voltage V_{B} at both ends of the battery pack, and there is a voltage constraint relation:

$${V}_{bus} = {V}_{B} + {V}_{C} \qquad ( 1 )$$

Referring to FIGS. 1 and 2 again, in the structure of the battery energy storage system, the first isolated DC/DC conversion circuit DC/DC₁ only processes a part of energy, and the remaining energy is transmitted between the first battery pack GB₁ and the DC bus. In the case of the same battery pack power, as compared to a full power conversion circuit that converts all battery power, in the battery energy storage system, a power processed by the first isolated DC/DC conversion circuit DC/DC₁ is less than that of the first battery pack GB₁, and can achieve more efficient power transmission under the same power converter. Accordingly, the first battery pack GB₁ and the first isolated DC/DC conversion circuit DC/DC₁ have the following relation:

$$k = ( {P}_{converter} / {P}_{B} ) < 1 \qquad ( 2 )$$

Wherein k is a ratio of the power of the first isolated DC/DC conversion circuit DC/DC₁ to the power of the first battery pack GB₁. In a charging mode of the battery pack, an efficiency relation of the battery energy storage system is:

$${η}_{PPC} = \frac{1}{1 + k ( 1 - {η}_{converter} )} = \frac{( 1 - k {η}_{converter} ) ( 1 - {η}_{converter} )}{1 + k ( 1 - {η}_{converter} )} + {η}_{converter} \qquad ( 3 )$$

In a discharging mode of the battery pack, an efficiency relation of the battery energy storage system is:

$${η}_{PPC} = 1 - k ( 1 - {η}_{converter} ) = ( 1 - k ) ( 1 - {η}_{converter} ) + {η}_{converter} \qquad ( 4 )$$

As can be known from the efficiency relation, the efficiency of the first isolated DC/DC conversion circuit DC/DC₁ is constant, the smaller k is, the higher the efficiency of the battery energy storage system will be, and it is necessary that η_{PPC}>η_{converter}. In the battery energy storage system, power specification of the first isolated DC/DC conversion circuit DC/DC₁ can be obviously lower than that of the full power conversion circuit, which reduces cost of the device, and largely improves a volume of the converter and an overall power density.

In this embodiment, the power flowing through the isolated DC/DC conversion circuit is only partial power of the entire battery energy storage system, and operation of the entire energy storage system can be controlled by regulating a voltage difference between the bus line and the battery pack, thereby controlling the large with the small, reducing a rated power of the converter, and saving cost. Moreover, in this embodiment, the isolated DC/DC conversion circuit also may use a full-bridge conversion circuit, a DAB conversion circuit, and the like, and the embodiments below are also applicable.

Further, referring to FIG. 2 again, when the LLC resonant conversion circuit has fault, a voltage at both end of the LLC resonant conversion circuit is abnormal, and after the battery management system detects abnormal of the battery, the first relay K₁ is disconnected, the first switch S1, the second switch S2, the third switch S3 and the fourth switch S4 are turned on, the fifth switch S5, the sixth switch S6, the seventh switch S7 and the eighth switch S8 are turned on, and the ninth switch S9 and the tenth switch S10 are turned off. Accordingly, energy in the first capacitor C1 and the second capacitor C2 may be released, thereby eliminating the potential safety risks during maintenance.

### Embodiment Two

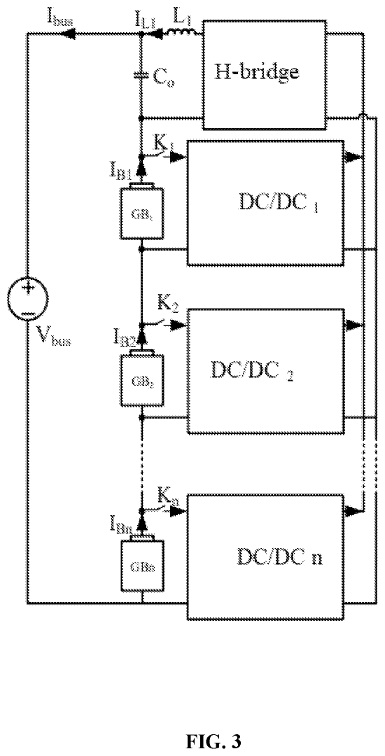

This embodiment provides a battery energy storage system with a step-up scheme suitable for application of a large power. Specifically, as shown in FIG. 3, FIG. 3 illustrates a topological schematic diagram of the battery energy storage system. The basic topological structure is to connect a battery pack and an input end of an isolated DC/DC conversion circuit in parallel to form a basic unit, then connect input ends of a plurality of basic units in series to obtain a basic input port, and connect output ends in parallel to obtain a basic output port, which is connected to the H-bridge circuit in series, and finally connect an output end of the H-bridge circuit in series to the basic input port to form an efficient and reliable intelligent battery pack system having a common DC bus.

Specifically, similar with the embodiment one, the battery energy storage system comprises a bus connection portion Vbus, a first battery pack GB₁, a first isolated DC/DC conversion circuit DC/DC₁, a first relay K₁, a H-bridge circuit, a filter inductor L1, and an output capacitor Co.

the first isolated DC/DC conversion circuit DC/DC₁ has an input end electrically connected to the first battery packGB₁, and an output end electrically connected to an input end of a H-bridge circuit.

the first relay K₁ is electrically connected between the first battery pack GB₁ and the input end of the first isolated DC/DC conversion circuit DC/DC₁, wherein when the first isolated DC/DC conversion circuit DC/DC₁ has fault, the first relay K₁ is disconnected.

the H-bridge circuit has an output end electrically connected to an output capacitor Co.

the filter inductor L1 is electrically connected between the output end of the H-bridge circuit and the output capacitor Co.

Moreover, on the basis of the embodiment one, the battery energy storage system of this embodiment further adds at least one second battery pack GB₂, at least one second isolated DC/DC conversion circuit DC/DC₂, at least one second relay K₂.

The second battery pack GB₂ comprises a plurality of single batteries connected in series or in parallel, wherein the output capacitor Co, the first battery pack GB₁ and the second battery pack GB₂ are connected in series and electrically connected between the positive bus connection end and the negative bus connection end,

the second isolated DC/DC conversion circuit DC/DC₂ has an input end electrically connected to the second battery pack GB₂, and an output end electrically connected to the input end of the H-bridge circuit,

the second relay K₂ is electrically connected between the second battery pack GB₂ and the input end of the second isolated DC/DC conversion circuit DC/DC₂, and when the second isolated DC/DC conversion circuit DC/DC₂ has fault, the second relay K₂ is disconnected. In this embodiment, a basic unit formed of the second battery pack GB₂, the second isolated DC/DC conversion circuit DC/DC₂ and the second relay K₂ in the battery energy storage system can be completely the same as the structure of a basic unit formed of the first battery pack GB₁, the first isolated DC/DC conversion circuit DC/DC₁ and the first relay K₁, but the system is not limited thereto, and is formed of at least two basic units.

In this embodiment, the step-up battery energy storage system suitable for application of a large power regulates SOC of the battery pack by controlling an input current of the isolated DC/DC conversion circuit through input parallel connection of the battery pack and the isolated DC/DC conversion circuit, and compensates for change of a terminal voltage of the basic unit due to charge and discharge, or provides a bus voltage and a voltage difference between the basic input ports as desired by the outside world by controlling an output voltage of the H-bridge circuit through series connection with the output end of the H-bridge circuit, thereby enhancing a voltage capacity. If a voltage of the common DC bus is stable, the basic units may emit or absorb power according to a capacity level of the battery pack itself, thereby achieving coordinated assignment of power among the basic units.

### Embodiment Three

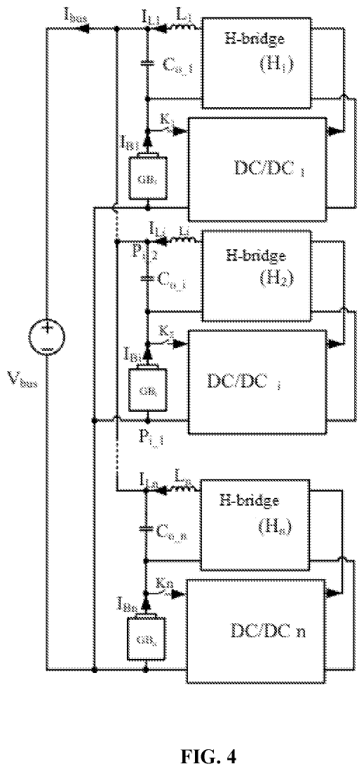

This embodiment provides a flow expanding scheme. Specifically, as shown in FIG. 4, FIG. 4 illustrates a topological schematic diagram of the flow expanding battery energy storage system, and the difference from the battery energy storage system in embodiment two is that the battery energy storage system in this embodiment is provided with a plurality of battery modules connected in parallel and electrically connected between the positive bus connection end and the negative bus connection end, wherein each battery module comprises a battery pack, an isolated DC/DC conversion circuit, a H-bridge circuit, a filter inductor, a relay and an output capacitor. In each battery module, the battery pack is connected in series to the output capacitor, the battery pack is electrically connected to an input end of the isolated DC/DC conversion circuit, an output end of the isolated DC/DC conversion circuit is electrically connected to an input end of the H-bridge circuit, an output end of the H-bridge circuit is electrically connected to the output capacitor, the filter inductor is electrically connected between the output end of the H-bridge circuit and the output capacitor, and the relay is electrically connected between the battery pack and the output end of the isolated DC/DC conversion circuit. A total current capacitor of the battery energy storage system is largely increased by connecting the plurality of battery modules in parallel, the control way of the system also becomes more flexible and changeable due to an increase of the number of battery modules, and SOC balance of the battery pack may be regulated, and an output current of the battery energy storage system is controlled by changing an output voltage of the H-bridge circuit. Moreover, as for each battery module, when the isolated DC/DC conversion circuit has fault, it may be isolated by disconnecting the relay, such that the isolated DC/DC conversion circuits that do not have fault in other modules continue to work.

### Embodiment Four

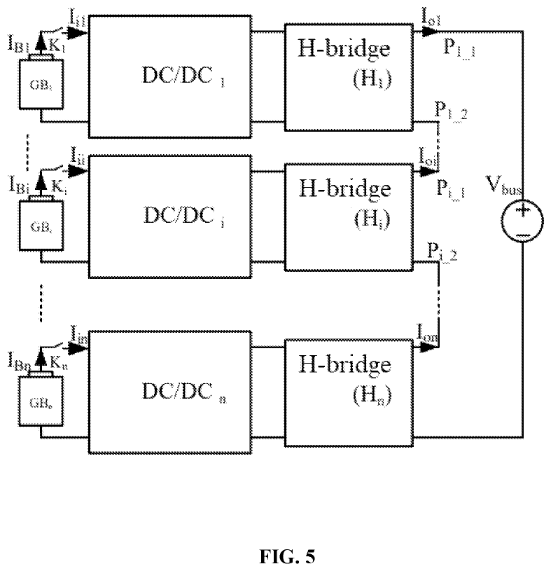

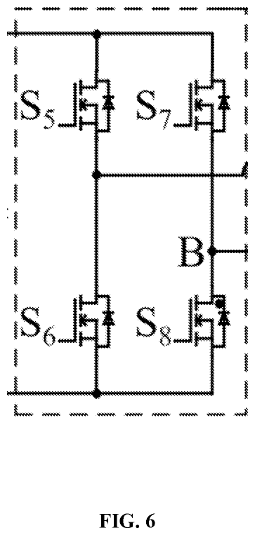

With respect to unbalance of capacitor and power caused by direct series or parallel connection of high voltage and large capacitor batteries, and different applications of an alternating current or a direct current as desired on the bus side, the existing energy storage system cannot satisfy the use requirements. This embodiment provides a battery energy storage system based on AC or DC output, and specifically, as show in FIGS. 5 and 6, FIG. 5 illustrates a topological schematic diagram of a battery energy storage system based on AC or DC output, and FIG. 6 illustrates a specific circuit diagram of a H-bridge circuit according to the fourth embodiment of the disclosure.

Specifically, the battery energy storage system comprises:

a bus connection portion Vbus comprising a positive bus connection end and a negative bus connection end;

a plurality of battery modules, as for any battery module, such as, the i-th battery module (i=1 . . . n), comprising:

a battery pack GBᵢ comprising a plurality of single batteries connected in series or in parallel;

an isolated DC/DC conversion circuit DC/DCᵢ having an input end electrically connected to the battery pack GBᵢ;

a relay Kᵢ electrically connected between the battery pack GBᵢ and the input end of the isolated DC/DC conversion circuit DC/DCᵢ; and

a H-bridge circuit Hᵢ, wherein the H-bridge circuit Hᵢ has an input end electrically connected to an output end of the isolated DC/DC conversion circuit DC/DCᵢ, and an output end electrically connected to a first port P_{i_1} and a second port P_{i_2} of the battery module, the first port P_{i_1} and the second port P_{i_2} corresponding to an upper end point and a lower end point of the output end of the battery module,

wherein the first port of any of the battery modules is electrically connected to the positive bus connection end or the second port of another battery module, and the second port of any of the battery modules is electrically connected to the negative bus connection end or the first port of another battery module.

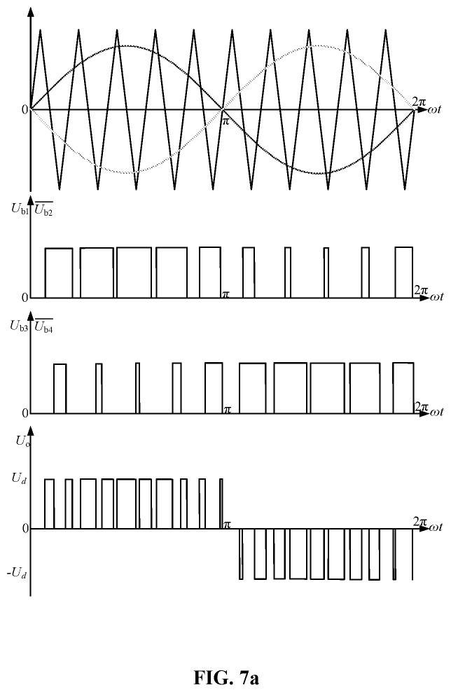

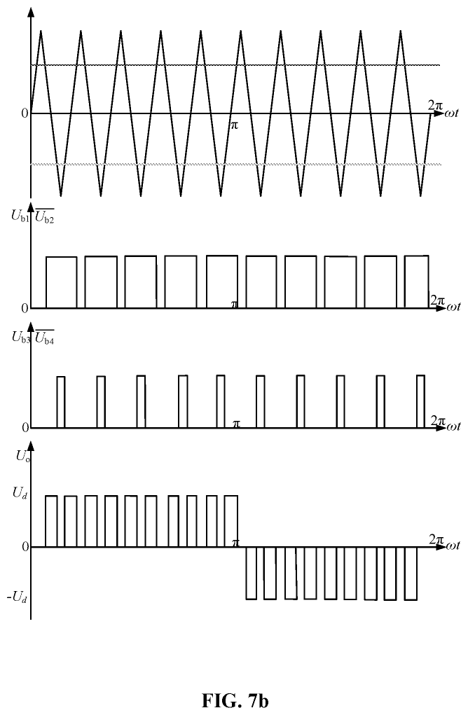

The battery energy storage system provided in this embodiment connects a bus line in series on an output side of the H-bridge circuit of each battery module, and in such connection way, the batteries form a pack, and an output voltage class of the system is greatly enhanced. Moreover, when the battery pack or the isolated DC/DC conversion circuit has fault, the faulted battery pack or DC/DC conversion circuit can be isolated by disconnecting the relay. High voltage AC or DC output may be achieved through different modulation ways used by the H-bridge circuit, FIG. 7a illustrates modulated principle waveforms based on AC output, and FIG. 7b illustrates modulated principle waveforms based on DC output.

As for any battery module, the topological structure of the H-bridge circuit is shown in FIG. 6, and specifically, the H-bridge circuit of each battery module comprises a third bridge arm comprising a fifth switch S5 and a sixth switch S6 connected in series, and a fourth bridge arm comprising a seventh switch S7 and an eighth switch S8 connected in series.

A switch driving signal of the H-bridge circuit is generated by modulation of a pair of modulation waves with opposite polarities and a carrier wave, the modulation waves comprise a sine wave or a constant wave, and the carrier wave comprises a triangular wave. This embodiment particularly generates the power switch driving signal using intersection of the two sine waves with opposite polarities and the bidirectional triangular carrier wave, or generates the power switch driving signal using intersection of the two constant waves with opposite polarities and the bidirectional triangular carrier wave. When the modulation waves are the sine wave, an output voltage of the H-bridge circuit is an AC voltage, and when the modulation waves are the constant wave, the output voltage of the H-bridge circuit is a DC voltage.

In this embodiment, the modulation wave u_{g} with a positive polarity and the carrier wave u_{c} are modulated to generate a first modulation signal U_{b1} and a second modulation signal Ū_{b2}, which are complementary signals, and the modulation wave −u_{g} with a negative polarity and the carrier wave u_{c} are modulated to generate a third modulation signal U_{b3} and a fourth modulation signal Ū_{b4}, which are complementary signals.

In specific implementation, during a positive half period of the output voltage Uo, the output voltage Uo is determined by logic of the first modulation signal U_{b1} and the fourth modulation signal Ū_{b4}, when the first modulation signal U_{b1} and the fourth modulation signal Ū_{b4} are both at high levels, the fifth switch S5 and the eighth switch S8 are turned on, such that the output voltage Uo=U_{d}, when at least one signal of the first modulation signal U_{b1} or the fourth modulation signal Ū_{b4} is at a low level, the fifth switch S5 and the sixth switch S6 are turned on, or, when at least one signal of the first modulation signal U_{b1} or the fourth modulation signal Ū_{b4} is at a low level, the seventh switch S7 and the eighth switch S8 are turned on, such that the output voltage Uo=0. Since during the positive half period, a high level area of the first modulation signal U_{b1} is always wider than a low level area of the third modulation signal U_{b3}, S5 and S6 are not turned on simultaneously, such that the output voltage Uo only includes two levels of U_{d} and 0.

During a negative half period of the output voltage Uo, the output voltage Uo is determined by logic of the second modulation signal Ū_{b2} and the third modulation signal U_{b3}, when the second modulation signal Ū_{b2} and the third modulation signal U_{b3} are both at high levels, the fifth switch S5 and the eighth switch S8 are turned on, such that the output voltage Uo=−U_{d}, when at least one signal of the second modulation signal or the third modulation signal is at a low level, the fifth switch S5 and the sixth switch S6 are turned on, or, when at least one signal of the second modulation signal or the third modulation signal is at a low level, the seventh switch S7 and the eighth switch S8 are turned on, such that the output voltage Uo=0. Since during the negative half period, a low level area of the first modulation signal U_{b1} is always wider than a high level area of the third modulation signal U_{b3}, S5 and S6 are not turned on simultaneously, such that the output voltage Uo only includes two levels of −U_{d} and 0. Moreover, since U_{d} has two state conversions within a carrier period, a frequency is twice of that of the switching tube, and a frequency of an output current of the filter inductor is improved twice, such that values of the filter inductor and the capacitor can be decreased, and cost and volume are reduced.

To sum up, the power flowing through the converter in the battery energy storage system provided by the disclosure is only a part of power of the entire energy storage system, and operation of the entire energy storage system can be controlled by regulating a voltage difference between the bus line and the battery pack, thereby controlling the large with the small, reducing a rated power of the converter, and saving cost. Meanwhile, the faulted DC/DC converter can be isolated, thereby ensuring normal operation of other DC/DC converters. Moreover, occasions such as an alternating current, a direct current and a large power with a low cost and a small volume may be achieved through different pack ways of the battery modules. Meanwhile, through different modulation ways of the H-bridge circuit, it is possible to achieve application of AC or DC output to high voltage occasions with different requirements. The system also achieves miniaturization and a light weight while improving operating efficiency of the energy storage system.

It shall be noted that in the text, the terms “comprise”, “include” or any other variations intend to cover non-exclusive inclusion, such that process, method, article or device including a series of factors comprise those factors, and also comprise other factors that are not clearly listed, or further comprise inherent factors of the process, method, article or device. In the case of no more limits, the factor defined by the sentence “comprising one . . . ” does not exclude other identical factor in the process, method, article or device including the factor. Moreover, it shall be pointed out that the range of the method and device in the embodiments of the disclosure is not limited to execute functions in accordance with the illustrated or discussed sequence, and may further comprise executing functions in accordance with the substantially simultaneous way or a reverse sequence based on the involved functions. For example, the described method may be executed in accordance with an order different from that described, and it is also possible to apply, omit or combine various steps. In addition, with reference to some examples, the described features may be combined in other examples.

The embodiments of the disclosure are described combining with the accompanying drawings above, but the disclosure are not limited thereto. The detailed embodiments are only illustrative, not limiting, and those ordinary in the art also may make various forms without departing from the aim and scope of the claims in the disclosure under the inspiration of the disclosure, and all belong to the protection of the disclosure.

What is claimed is:

1. A battery energy storage system, comprising:
a bus connection portion, comprising a positive bus connection end and a negative bus connection end;
a first battery pack, comprising a plurality of single batteries connected in series, or a plurality of single batteries connected in parallel;
an output capacitor, wherein the output capacitor is connected in series to the first battery pack, and the output capacitor and the first battery pack are electrically connected between the positive bus connection end and the negative bus connection end;
a H-bridge circuit, wherein an output end of the H-bridge circuit is electrically connected to the output capacitor;
a filter inductor, wherein the filter inductor is electrically connected between the output end of the H-bridge circuit and the output capacitor;
a first isolated DC/DC conversion circuit, wherein an input end of the first isolated DC/DC conversion circuit is electrically connected to the first battery pack, and an output end of the first isolated DC/DC conversion circuit is electrically connected to an input end of the H-bridge circuit; and
a first relay, wherein the first relay is electrically connected between the first battery pack and the input end of the first isolated DC/DC conversion circuit, and when the first isolated DC/DC conversion circuit has fault, the first relay is disconnected.

2. The battery energy storage system according to claim 1, wherein the first isolated DC/DC conversion circuit comprises a LLC resonant conversion circuit which is electrically connected to a first capacitor, a switching circuit, a resonant network, a transformer, a rectifier circuit and a second capacitor sequentially, the switching circuit comprises a first bridge arm and a second bridge arm, and the first capacitor, the first bridge arm and the second bridge arm are connected in parallel, the first bridge arm comprises a first switch and a second switch, the first switch and the second switch is connected in series, the second bridge arm comprises a third switch and a fourth switch, the third switch and the fourth switch is connected in series, the resonant network comprises a resonant inductor and a resonant capacitor, the H-bridge circuit comprises a third bridge arm and a fourth bridge arm, and the second capacitor, the third bridge arm and the fourth bridge arm are connected in parallel, the third bridge arm comprises a fifth switch and a sixth switch, the fifth switch and the sixth switch is connected in series, the fourth bridge arm comprises a seventh switch and an eighth switch, the rectifier circuit comprises a ninth switch and a tenth switch, when the first relay is disconnected, the first switch, the second switch, the third switch and the fourth switch are turned on, the fifth switch, the sixth switch, the seventh switch and the eighth switch are turned on, and the ninth switch and the tenth switch are turned off.

3. The battery energy storage system according to claim 1, further comprising:
a second battery pack, comprising a plurality of single batteries connected in series or in parallel, and the output capacitor, the first battery pack and the second battery pack are connected in series, and the output capacitor, the first battery pack and the second battery pack are electrically connected between the positive bus connection end and the negative bus connection end;
a second isolated DC/DC conversion circuit, an input end of the second isolated DC/DC conversion circuit is electrically connected to the second battery pack, and an output end f the second isolated DC/DC conversion circuit is electrically connected to the input end of the H-bridge circuit; and
a second relay electrically, wherein the second relay electrically is connected between the second battery pack and the input end of the second isolated DC/DC conversion circuit, and when the second isolated DC/DC conversion circuit has fault, the second relay is disconnected.

4. A battery energy storage system, comprising:
a bus connection portion, comprising a positive bus connection end and a negative bus connection end;
a plurality of battery modules, each comprising:
a battery pack, comprising a plurality of single batteries connected in series or in parallel;
an output capacitor, wherein the output capacitor is connected in series to the battery pack;
a H-bridge circuit, wherein an output end of the H-bridge circuit is electrically connected to the output capacitor;
a filter inductor, wherein the filter inductor is electrically connected between the output end of the H-bridge circuit and the output capacitor;
an isolated DC/DC conversion circuit, wherein an input end of the isolated DC/DC conversion circuit is electrically connected to the battery pack, and an output end of the isolated DC/DC conversion circuit is electrically connected to an input end of the H-bridge circuit; and
a relay, wherein the relay is electrically connected between the battery pack and the input end of the isolated DC/DC conversion circuit, and when the isolated DC/DC conversion circuit has fault, the relay is disconnected;
wherein the plurality of battery modules are connected in parallel and electrically connected between the positive bus connection end and the negative bus connection end.

5. A battery energy storage system, comprising:
a bus connection portion, comprising a positive bus connection end and a negative bus connection end;
a plurality of battery modules, each comprising:
a battery pack, comprising a plurality of single batteries connected in series or in parallel;
an isolated DC/DC conversion circuit, wherein an input end of the isolated DC/DC conversion circuit is electrically connected to the battery pack;
a relay, wherein the relay is electrically connected between the battery pack and the input end of the isolated DC/DC conversion circuit; and
a H-bridge circuit, wherein an input end of the H-bridge circuit is electrically connected to an output end of the isolated DC/DC conversion circuit, and an output end of the H-bridge circuit is electrically connected to a first port and a second port of the battery modules;
wherein the first port of any of the battery modules is electrically connected to the positive bus connection end or the second port of another battery module, and the second port of any of the battery modules is electrically connected to the negative bus connection end or the first port of another battery module.

6. The battery energy storage system according to claim 5, wherein,
the H-bridge circuit further comprises a third bridge arm and a fourth bridge arm, wherein the third bridge arm comprises a fifth switch and a sixth switch connected in series, and the fourth bridge arm comprises a seventh switch and an eighth switch connected in series.

7. The battery energy storage system according to claim 6, wherein a switch driving signal of the H-bridge circuit is generated by modulation of a pair of modulation waves with opposite polarities and a carrier wave, the modulation waves comprise a sine wave or a constant wave, and the carrier wave comprises a triangular wave.

8. The battery energy storage system according to claim 7, wherein when the modulation waves are the sine wave, an output voltage of the H-bridge circuit is an AC voltage, and when the modulation waves are the constant wave, the output voltage of the H-bridge circuit is a DC voltage.

9. The battery energy storage system according to claim 7, wherein the modulation wave with a positive polarity and the carrier wave are modulated to generate a first modulation signal and a second modulation signal, the modulation wave with a negative polarity and the carrier wave are modulated to generate a third modulation signal and a fourth modulation signal, the first modulation signal and the second modulation signal are complementary, and the third modulation signal and the fourth modulation signal are complementary.

10. The battery energy storage system according to claim 9, wherein during a positive half period of the output voltage, when the first modulation signal and the fourth modulation signal are both at high levels, the fifth switch and the eighth switch are turned on, and when the first modulation signal or the fourth modulation signal is at a low level, the fifth switch and the sixth switch are turned on, or, when the first modulation signal or the fourth modulation signal is at a low level, the seventh switch and the eighth switch are turned on;
during a negative half period of the output voltage, when the second modulation signal and the third modulation signal are both at high levels, the fifth switch and the eighth switch are turned on, and when the second modulation signal or the third modulation signal is at a low level, the fifth switch and the sixth switch are turned on, or, when the second modulation signal or the third modulation signal is at a low level, the seventh switch and the eighth switch are turned on.
